(19) United States
(12) Patent Application Publication
(10) Pub. No.: US 2008/0137507 A1
(43) Pub. Date: Jun. 12, 2008

(54) Method for storing data compatible with DVD read/write formats to hard disk, HD-DVD, or Blue-Ray DVD

(75) Inventors: Yan-Long Sun, Hangzhou City (CN); Ming-Xiang Shen, Hangzhou City (CN)

Correspondence Address: BACON & THOMAS, PLLC, 625 SLATERS LANE, FOURTH FLOOR, ALEXANDRIA, VA, 22314, US

(73) Assignee: ArcSoft, Inc., Fremont, CA (US)

(21) Appl. No.: 11/635,669

(22) Filed: Dec. 8, 2006

(51) Int. Cl. G11B 3/64

(52) U.S. Cl. 369/85

(57) ABSTRACT

The present invention is to provide a method to be used on an electronic device, which employs the demultiplexing process to divide the data streams from video file compatible with DVD read/write formats, or video file from several DVD disks; into several independent and separate files; the data streams include audio, video, and subtitle; subsequently, the data streams that include audio, video, and subtitle are subject to the multiplexing process in accordance with UDF 2.50 or UDF 2.60 formats, in order to combine the data streams into a new video file. In the method, because the demultiplexing process and the multiplexing process simply divides the data streams that include audio, video, and subtitles into separate files; the processes does not encode or decode these data streams, and thus the original video quality and audio quality can be preserved

### FIELD OF THE INVENTION

The invention relates to a method for storing data compatible with DVD read/write formats, and more particularly, to a method of storing data compatible with DVD read/write formats to hard disk, HD-DVD, or Blue-Ray DVD.

### DESCRIPTION OF PRIOR ART

Rapid recent advances in the electronics technology have given rise to constant improvements in the performance of computers and related products, which also helped lower prices along the way. Consequently, all types of computers and related products have become more common in people's daily lives and are now essential tools for working and learning. On the other hand, all sorts of storage media for storing files of large sizes have also been developed. Currently, the DVD disk is a storage media popular among users for its enormous storage capacity, which has as high as 4.7 G of capacity for storing data. DVD disks can be roughly divided into three categories on the basis of different read/write formats, which are the DVD-VIDEO, DVD+VR, and DVD−VR formats. Users around the world have become accustomed to using DVD disks for storing large amount of data such as digital video files, music files, and data for works. As a result, users usually have dozens or even hundreds of DVD disks that not only take up a lot of physical space, but also cause inconvenience to users when managing and searching for these files.

In light of the limited storage capacity in the current DVD disks, the industry has spent a lot of effort on developing a new generation of standards for video disks, which are the standards for HD-DVD and Blue-Ray DVD disks (or abbreviated as HD/BD). Generally speaking, a single side of HD-DVD disk has the capacity for storing 15 G of data, while the Blue-Ray DVD disk has the capacity for storing more than 25 G of data. Therefore, a single HD-DVD or Blue-Ray DVD disk can be used to save the data from several DVD disks with an individual storage capacity of 4.7 G In order to make the most of the new generation of video disk standards, it is urgent to develop a tool for storing the data from several DVD disks to HD-DVD or Blue-Ray DVD disk, and thus enabling users to easily combine and transfer the data stored on DVD disks to a single HD-DVD or Blue-Ray DVD disk. In other words, the tool effectively reduces the tedious time and procedure required for transferring data as in the traditional methods, and allows users to add, remove, and edit data that has been combined and stored on HD-DVD or Blue-Ray DVD disk; the development of such a tool is a major aim of the industry at this stage.

### SUMMARY OF THE INVENTION

In light of the problem of limited storage capacity in traditional DVD disks, a method for storing data compatible with DVD read/write formats to hard disk, HD-DVD, or Blue-Ray DVD has been disclosed in this invention. By using this method, users can promptly convert the DVD-compatible video to a file stored on a hard disk, or combine several DVD disks to a video file compatible with the read/write formats of HD-DVD or Blue-Ray DVD, and store such new video file to hard disk, HD-DVD, or Blue-Ray DVD. Therefore, users are allowed to view the new video file on the players and computers that support HD-DVD or Blue-Ray DVD, and add, remove, or edit the content of the video file.

A primary objective of the invention is to propose a method to be used on an electronic device, which employs the demultiplexing process to divide the data streams from video file compatible with DVD read/write formats, or video file from several DVD disks; into several independent and separate files; the data streams include audio, video, and subtitle; subsequently, the data streams that include audio, video, and subtitle are subject to the multiplexing process in accordance with UDF 2.50 or UDF 2.60 formats, in order to combine the data streams into a new video file. In the method, because the demultiplexing process and the multiplexing process simply divides the data streams that include audio, video, and subtitles into separate files; the processes does not encode or decode these data streams, and thus the original video quality and audio quality can be preserved.

A further objective of the invention is to use the method for combining the data streams from the files stored on DVD disks via DVD-VIDEO, DVD+VR, or DVD−VR formats, or from the files stored on hard disk that is compatible with the formats mentioned above; into a new video file, because the new video file has higher data flow rate, it can be recorded into hard disk, HD-DVD, or Blue-Ray DVD at high conversion speed.

To allow for better understanding about the objectives, the underlying mechanism, and the effects of the method described in this disclosure, the preferred embodiment and a related figure of the method are given to achieve this purpose, as described in the following sections.

### BRIEF DESCRIPTION OF DRAWINGS

FIG. 1 is a schematic view showing the process of transferring the data on DVD disks into hard disk, HD-DVD, or Blue-Ray DVD according to the invention.

### DETAILED DESCRIPTION OF PREFERRED EMBODIMENTS

In the application of electronics and communication, the multiplexer (abbreviated as mux) is a device for sending information from two or more data sources to a single channel via the method of multiplexing, and it can also be used to combine several electrical signals into a single signal. As a result, the industry had developed many different types of multiplexers to handle the variety of analog and digital circuits. When it comes to the processing of digital signal, the multiplexer is used to combine several separate and independent digital data streams into a single digital data stream with higher data flow rate, so that the multiple data streams can be transferred from a device to another device through a physical interface or a link. On the other hand, the device for receiving the single digital data stream must be equipped with a complementary demultiplexer (abbreviated as demux), which is used to divide the single digital data stream with higher data flow rate into several independent original data streams that have lower data flow rate.

The current DVD disks and the new generation of HD-DVD and Blue-Ray DVD disks rely on different encoding methods for the video and audio carried on the disks; the encoding methods are listed below:

| | Encoding | |
|---|---|---|
| | methods for video data | Encoding methods for audio data |
| DVD | MPEG2 | MPA, AC3, LPCM |
| HD-DVD | MPEG2, SMPT1-VC1, | MPA, AC3, LPCM, DD+, |
| | MPEG4 AVC | HD-DTS . . . |
| Blue-Ray | MPEG2, SMPT1-VC1, | AC3, LPCM, DD+, HD-DTS . . . |
| DVD | MPEG4 AVC | |

From the table, it can be seen that the encoding method for the video of DVD disks (e.g. MPEG2) can also be applied to HD-DVD and Blue-Ray DVD, and the encoding method for the audio of DVD disks (e.g. MPA, AC3, and LPCM) can still be applied to HD-DVD; though the MPA encoding method cannot be applied to Blue-Ray DVD, other encoding methods like AC3 and LPCM are still applicable to Blue-Ray DVD. Since the encoding methods for video and audio are almost identical in DVD, HD-DVD, and Blue-Ray DVD, the video on ordinary DVD disks can be directly transferred to HD-DVD and Blue-Ray DVD without the need to re-encode. The same rule also applies to most of the audio data on ordinary DVD disks, with the exception of audio data encoded with the MPA encoding method, which needs to be converted before being recorded into Blue-Ray DVD. However, MPA encoded audio only represents a small proportion of DVD's, and if conversion is required, it can be achieved quite quickly.

The Universal Disk Format (abbreviated as UDF) is a file system based on an independent operating system, and is usually applied to DVD and other digital media. When UDF is combined with the technology of packet writing, it allows files to be added into or removed from a disk via normal file system mechanisms. In other words, the combination of UDF with packet writing technology enable users to manipulate data in the disks in the same way as they manipulate data on hard disks, floppy disks, or USB flash drives. In the various versions of UDF, Revision 1.02 is used for DVD-Video disks; Revision 1.50 had been included with the VAT structure and sparing tables, which allows it to support rewritable functions in CD-R/DVD-R disks, and the defect management function in CD-RW, DVD−RW, and DVD+RW rewritable disks; in Revision 2.00, the function of support for streaming files while recording DVD was added, as well as support for real-time files and simplified directory management; Revision 2.01 arrived after fixing the bugs in Revision 2.00, in which many of the unclarified parts in the UDF standard have been resolved. Revisions 2.50 or 2.60 have been included with many of the latest functions, which are applicable to the new generation of Blue-Ray DVD and HD-DVD.

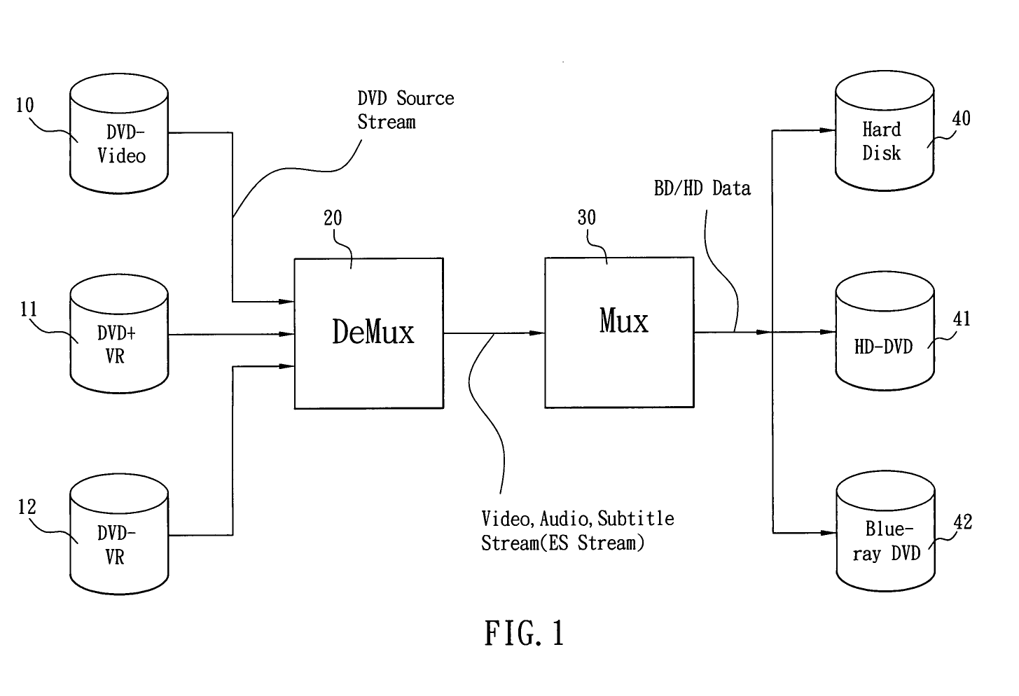

Since the encoding methods of video and audio for DVD, HD-DVD, and Blue-Ray DVD are universal, the invention has applied the fundamental mechanisms of multiplexing and demultiplexing mentioned above to methods of storing data compatible with DVD read/write formats to hard disk, HD-DVD or Blue-Ray DVD. As shown in FIG. 1, the method uses a demultiplexer 20 to read the video file that is compatible with DVD read/write formats, or the video file on DVD disks with different read/write formats such as DVD-VIDEO 10, DVD+VR 11, and DVD−VR 12, and then carry out the demultiplexing process for data streams from the video file that include video, audio, and subtitle, in which the video, audio, and subtitle from the video file are then divided into separate files; subsequently, a multiplexer 30 is used to receive the separate video, audio, and subtitle, and then carry out the multiplexing process in order to combine the data streams into a new video file with higher data flow rate in a predetermined standard UDF format (such as Revision 2.50 or 2.60) of HD-DVD or Blue-ray DVD; finally, the new video file is recorded into hard disk 40, HD-DVD 41, or Blue-Ray DVD 42 at a relatively high conversion speed. As a result, users can not only view the new video file on the player and computer that support HD-DVD or Blue-Ray DVD, but also make further changes to the content of the new video file, such as adding, removing, or editing the content.

To further elucidate the underlying concept of the invention, and to prove the efficacy of the invention, a preferred embodiment has been presented and described as below:

The embodiment was implemented on a notebook computer with 512M of extended memory and a PIV 3.0 CPU; the operating system of the notebook computer was WINDOWS XP, and a movie named “The Stepford Wives” recorded on a DVD-VIDEO disk was to be converted into a video file compatible with the HD-DVD and Blue-Ray DVD formats and stored into the hard disk of the notebook computer; the total length of the movie was 5567 seconds (1 hour and 33 minutes), and the size of the movie's video file was 3.8 G. In the embodiment, when the content of DVD-VIDEO 10 was undergoing the demultiplexing process as indicated in FIG. 1, the demultiplexer 20 of the notebook computer was using UDF 1.0 as its read lib; in other words, UDF 1.0 was used to read the video file on the DVD-VIDEO disk in the drive. The demultiplexer 20 provides users with a configuration interface, which allowed users to fill in the information required for the demultiplexing process (e.g. titles, chapters, or time), and an information display interface was also provided for users to obtain information about the DVD-VIDEO disk in the drive. The demultiplexer 20 also has a splitter for splitting the data streams from the video file that included video, audio, and subtitle into separate files, during which the subtitle was converted into BMP data that can be employed by the multiplexer 30 in the following multiplexing process. In this embodiment, the multiplexer 30 received the separate files that included video, audio, and subtitle from the demultiplexer 20, and then launched multiplexing process for the data streams that corresponded to the files by using UDF 2.5 or UDF 2.6 as the write lib; subsequently, the data streams were combined into a new video file with higher data flow rate according to the UDF format, and the new video file was then recorded into hard disk 40 at high conversion speed according to UDF 2.5 or UDF 2.6. Consequently, it only required 700 seconds (12 minutes) to convert the movie content on DVD-VIDEO 10 with the length of 1 hour and 33 minutes into a video file compatible with the formats of HD-DVD or Blue-Ray DVD, and store on hard disk 40. Moreover, it also allowed users to view the video file on the notebook computer, and add, remove, as well as edit the content of the video file.

It should be noted that the demultiplexing process and the multiplexing process described in the invention do not encode or decode the original data of the video file, and thus the processing does not affect the visual or audio quality of the original data. In addition, because encoding and decoding of a video file is completely unnecessary using this method, the time required for converting, the DVD content to a video file compatible with the read/write formats of HD-DVD or Blue-Ray DVD, and then recording the video file onto hard disk, HD-DVD, or Blue-Ray DVD, is only a fraction of the time needed for the encoding and decoding processes. Therefore, the invention not only converts and records the DVD content in a relatively shorter period of time, it also maintains the video and audio quality of the original data. In addition, it should be pointed out that the “data compatible with DVD read/write formats” described in the invention not only encompasses the data stored in DVD-ROM, DVD-RAM, DVD+R, DVD+RW, DVD−R, DVD−RW, DVD+R DL or DVD−R DL via DVD-VIDEO, DVD+VR, or DVD−VR read/write formats; but also includes the data stored on a hard disk via DVD-VIDEO, DVD+VR, or DVD−VR read/write formats.

While the invention herein disclosed has been described by means of specific embodiments, numerous modifications and variations could be made thereto by those skilled in the art without departing from the scope and spirit of the invention set forth in the claims.

What is claimed is:

1. A method for storing data compatible with DVD read/write formats to hard disk, HD-DVD, or Blue-Ray DVD, which is implemented to an electronic device, comprising the steps of:
demultiplexing data streams from the media files compatible with DVD read/write formats according to DVD read/write formats to divide said data streams into separate and independent files including video, audio and subtitle; and
multiplexing said files including video, audio and subtitle in accordance with the read/write formats of HD-DVD or Blue-Ray DVD to combine data streams of said files into a new media file.

2. The method cited in claim 1, wherein said demultiplexing process using the read/write formats compatible with DVD read/write formats as the read lib to read the media files on DVD disks.

3. The method cited in claim 2, wherein said read lib being either UDF 1.0 or UDF 2.0.

4. The method cited in claim 1, wherein said multiplexing process using the read/write formats compatible with HD-DVD or Blue-Ray DVD read/write formats as the write lib to record the new media files to hard disk, HD-DVD, or Blue-Ray DVD.

5. The method cited in claim 4, wherein said write lib being either UDF 2.5 or UDF 2.6.

6. The method cited in claim 1, wherein said subtitles being converted into BMP data before said multiplexing process and being used by said multiplexing process.

7. The method cited in claim 1, wherein said media files compatible with DVD read/write formats being stored on DVD-ROM, DVD-RAM, DVD+R, DVD+RW, DVD−R, DVD−RW, DVD+R DL, or DVD−R DL disks via DVD-VIDEO, DVD+VR, or DVD−VR read/write formats.

8. The method cited in claim 1, wherein said media files compatible with DVD read/write formats being stored on hard disks via DVD-VIDEO, DVD+VR, or DVD−VR read/write formats.
